(19) United States
(12) Patent Application Publication
(10) Pub. No.: US 2010/0101493 A1
(43) Pub. Date: Apr. 29, 2010

(54) Dispense System

(75) Inventors: Jared L. Hodge, Austin, TX (US); Van Nguyen Truskett, Austin, TX (US); Matthew S. Shafran, Austin, TX (US); Bharath Thiruvengadachari, Round Rock, TX (US)

Correspondence Address: MOLECULAR IMPRINTS, PO BOX 81536, AUSTIN, TX, 78708-1536, US

(73) Assignee: MOLECULAR IMPRINTS, INC., Austin, TX (US)

(21) Appl. No.: 12/605,578

(22) Filed: Oct. 26, 2009

Related U.S. Application Data
(60) Provisional application No. 61/108,628, filed on Oct. 27, 2008.
(60) Provisional application No. 61/109,534, filed on Oct. 30, 2008.

(51) Int. Cl. B05C 11/02; B23P 6/00

(52) U.S. Cl. 118/697; 29/402.08

(57) ABSTRACT

Systems and methods for locating and eliminating and/or minimizing non-functional nozzles of dispense systems are described.

### CROSS-REFERENCE TO RELATED APPLICATION

This application claims the benefit under 35 U.S.C. §119(e)(1) of U.S. of U.S. Provisional No. 61/108,628, filed Oct. 27, 2008, and of U.S. Provisional No. 61/109,534 filed Oct. 30, 2009, both of which are hereby incorporated by reference.

### BACKGROUND INFORMATION

Nano-fabrication includes the fabrication of very small structures that have features on the order of 100 nanometers or smaller. One application in which nano-fabrication has had a sizeable impact is in the processing of integrated circuits. The semiconductor processing industry continues to strive for larger production yields while increasing the circuits per unit area formed on a substrate, therefore nano-fabrication becomes increasingly important. Nano-fabrication provides greater process control while allowing continued reduction of the minimum feature dimensions of the structures formed. Other areas of development in which nano-fabrication has been employed include biotechnology, optical technology, mechanical systems, and the like.

An exemplary nano-fabrication technique in use today is commonly referred to as imprint lithography. Exemplary imprint lithography processes are described in detail in numerous publications, such as U.S. Patent Publication No. 2004/0065976, U.S. Patent Publication No. 2004/0065252, and U.S. Pat. No. 6,936,194, all of which are herein incorporated by reference.

An imprint lithography technique disclosed in each of the aforementioned U.S. patent publications and patent includes formation of a relief pattern in a polymerizable layer, and transferring a pattern corresponding to the relief pattern into an underlying substrate. The substrate may be coupled to a motion stage to obtain a desired positioning to facilitate the patterning process. The patterning process uses a template spaced apart from the substrate and a formable liquid applied between the template and the substrate. The formable liquid is solidified to form a rigid layer that has a pattern conforming to a shape of the surface of the template that contacts the formable liquid. After solidification, the template is separated from the rigid layer such that the template and the substrate are spaced apart. The substrate and the solidified layer are then subjected to additional processes to transfer a relief image into the substrate that corresponds to the pattern in the solidified layer.

Formable liquid may be applied using a fluid dispenser having nozzles. When using the dispenser, nozzles may become clogged and/or deviate due to evaporation from the nozzles, particles in the formable liquid, inadvertent contact with the dispenser, physical and/or electrical failure of the nozzles, and the like. The absence and/or misplacement of formable liquid between the substrate and template may result in non-filled regions and/or non-uniformity in the solidified layer.

### BRIEF DESCRIPTION OF DRAWINGS

So that features and advantages of the present invention may be understood in detail, a more particular description of embodiments of the invention may be had by reference to the embodiments illustrated in the appended drawings. It is to be noted, however, that the appended drawings only illustrate typical embodiments of the invention, and are therefore not to be considered limiting of its scope, for the invention may admit to other equally effective embodiments.

FIG. 1 illustrates a simplified side view of a lithographic system.

FIG. 2 illustrates a side view of the substrate illustrated in FIG. 1, having a patterned layer thereon.

FIG. 3 illustrates a simplified diagram of an exemplary fluid dispense system.

FIG. 4 illustrates a diagram of an exemplary fluid transfer system.

FIG. 5 illustrates a block diagram of an exemplary fluid dispense system including a vision system.

FIG. 6 illustrates an exemplary drop pattern image and associated nozzles of a fluid dispense system.

FIGS. 7A and 7B illustrate exemplary detection systems for detecting fluid egressing from a nozzle of a dispense head.

FIG. 8 illustrates an exemplary monitoring system for capturing one or more images of fluid egressing from a nozzle of a dispense head.

FIGS. 9A and 9B illustrate an exemplary diagnostic system for determining functional and non-functional nozzles.

FIG. 10 illustrates an exemplary gravimetric system to monitor changes in mass of fluid dispensed by a fluid dispense system.

FIG. 11 illustrates an exemplary drop pattern image and associated nozzles of a fluid dispense system.

FIGS. 12-14 illustrate exemplary lossless techniques to minimize the effects of a non-functional nozzle.

FIGS. 15-18 illustrate exemplary lossy techniques to minimize the effects of a non-functional nozzle.

FIG. 19 illustrates a flow chart of an exemplary method to identify non-functional nozzles and obtain a specified drop pattern.

FIG. 20 illustrates a flow chart of an exemplary method to maintain a dispense head.

### DETAILED DESCRIPTION

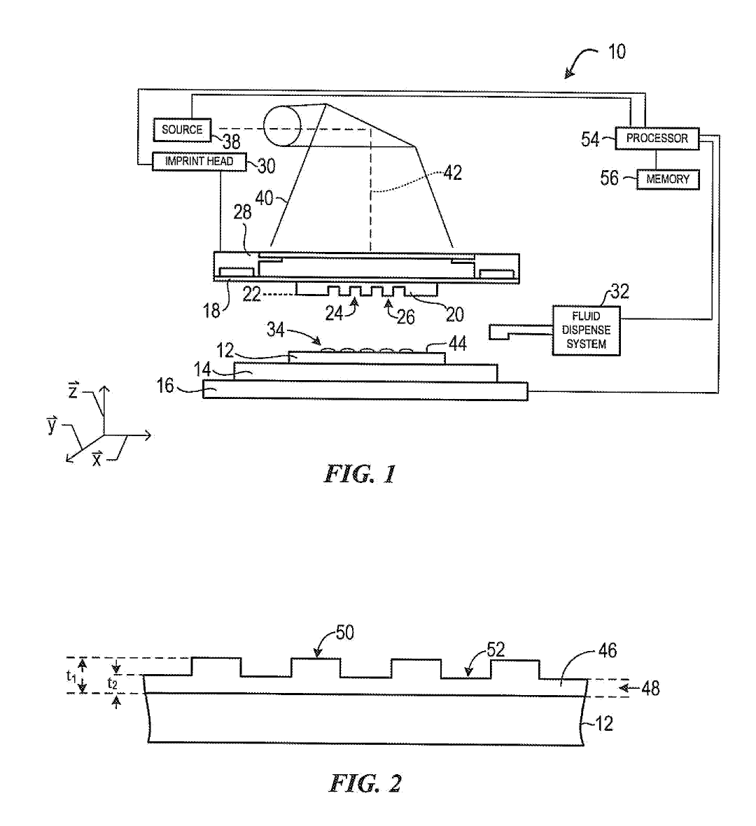

Referring to the figures, and particularly to FIG. 1, illustrated therein is a lithographic system 10 used to form a relief pattern on substrate 12. Substrate 12 may be coupled to substrate chuck 14. As illustrated, substrate chuck 14 is a vacuum chuck. Substrate chuck 14, however, may be any chuck including, but not limited to, vacuum, pin-type, groove-type, electromagnetic, electrostatic, and/or the like. Exemplary chucks are described in U.S. Pat. No. 6,873,087, which is hereby incorporated by reference.

Substrate 12 and substrate chuck 14 may be further supported by stage 16. Stage 16 may provide motion along the x-, y-, and z-axes. Stage 16, substrate 12, and substrate chuck 14 may also be positioned on a base (not shown).

Spaced-apart from substrate 12 is a template 18. Template 18 generally includes a mesa 20 extending therefrom towards substrate 12, mesa 20 having a patterning surface 22 thereon. Further, mesa 20 may be referred to as mold 20. Template 18 and/or mold 20 may be formed from such materials including, but not limited to, fused-silica, quartz, silicon, organic polymers, siloxane polymers, borosilicate glass, fluorocarbon polymers, metal, hardened sapphire, and/or the like. As illustrated, patterning surface 22 comprises features defined by a plurality of spaced-apart recesses 24 and/or protrusions 26, though embodiments of the present invention are not limited to such configurations. Patterning surface 22 may define any original pattern that forms the basis of a pattern to be formed on substrate 12.

Template 18 may be coupled to chuck 28. Chuck 28 may be configured as, but not limited to, vacuum, pin-type, groove-type, electromagnetic, electrostatic, and/or other similar chuck types. Exemplary chucks are further described in U.S. Pat. No. 6,873,087, which is hereby incorporated by reference. Further, chuck 28 may be coupled to imprint head 30 such that chuck 28 and/or imprint head 30 may be configured to facilitate movement of template 18.

System 10 may further comprise a fluid dispense system 32. Fluid dispense system 32 may be used to deposit polymerizable material 34 on substrate 12. Polymerizable material 34 may be positioned upon substrate 12 using techniques such as drop dispense, spin-coating, dip coating, chemical vapor deposition (CVD), physical vapor deposition (PVD), thin film deposition, thick film deposition, and/or the like. Polymerizable material 34 may be disposed upon substrate 12 before and/or after a desired volume is defined between mold 20 and substrate 12 depending on design considerations. Polymerizable material 34 may comprise a monomer mixture as described in U.S. Pat. No. 7,157,036 and U.S. Patent Publication No. 2005/0187339, all of which are hereby incorporated by reference.

Referring to FIGS. 1 and 2, system 10 may further comprise an energy source 38 coupled to direct energy 40 along path 42. Imprint head 30 and stage 16 may be configured to position template 18 and substrate 12 in superimposition with path 42. System 10 may be regulated by a processor 54 in communication with stage 16, imprint head 30, fluid dispense system 32, and/or source 38. In particular, the processor 54 is coupled to memory 56 and the memory 56 may include one or more computer-readable media that include instructions executable by the processor 54 to regulate the system 10. For example, the memory 56 may include instructions executable by the processor 54 to identify non-functional nozzles of the fluid dispense system 32.

Either imprint head 30, stage 16, or both vary a distance between mold 20 and substrate 12 to define a desired volume therebetween that is filled by polymerizable material 34. For example, imprint head 30 may apply a force to template 18 such that mold 20 contacts polymerizable material 34. After the desired volume is filled with polymerizable material 34, source 38 produces energy 40, e.g., ultraviolet radiation, causing polymerizable material 34 to solidify and/or cross-link conforming to shape of a surface 44 of substrate 12 and patterning surface 22, defining a patterned layer 46 on substrate 12. Patterned layer 46 may comprise a residual layer 48 and a plurality of features shown as protrusions 50 and recessions 52, with protrusions 50 having thickness t₁ and residual layer having a thickness t₂.

The above-mentioned system and process may be further employed in imprint lithography processes and systems referred to in U.S. Pat. No. 6,932,934, U.S. Patent Publication No. 2004/0124566, U.S. Patent Publication No. 2004/0188381, and U.S. Patent Publication No. 2004/0211754, each of which is hereby incorporated by reference.

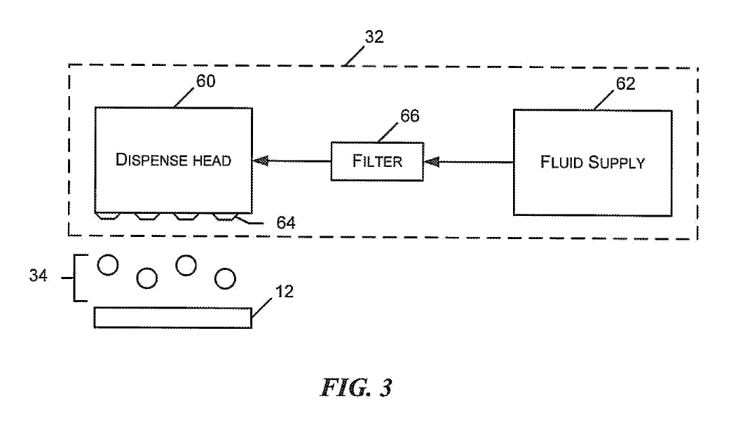

FIG. 3 illustrates a block diagram of an exemplary fluid dispense system 32. The fluid dispense system 32 includes a dispense head 60 that receives fluid from a fluid supply 62. The fluid of the fluid supply 62 may include any industrial fluid, such as a biological fluid or the polymerizable material 34. The fluid supply 62 may include one or more reservoirs to store fluid. The fluid may be transferred from the fluid supply 62 to the dispense head 60 by a number of methods, such as a pressure differential between the fluid supply 62 and the dispense head 60, a pumping device, or a combination thereof.

In the embodiment illustrated in FIG. 3, polymerizable material 34 is dispensed from one or more of a plurality of nozzles 64 of the dispense head 60 onto a substrate 12. For example, the polymerizable material 34 may be dispensed from particular nozzles 64 in order to form a pattern of drops on the substrate 12. Although FIG. 3 shows a two-dimensional view of the nozzles 64, the nozzles 64 may be arranged in a grid with a number of rows and columns of the nozzles 64. In some embodiments, the nozzles of a particular row may be aligned with the nozzles of other rows of the grid. In other embodiments, the nozzles of a particular row may be offset with respect to nozzles of other rows of the grid.

The fluid dispense system 32 may also include a filter 66. The filter 66 may separate particles of a specified size from the fluid of the fluid supply 62. For example, the filter 66 may separate particles greater than 50 nm from the fluid. In this way, clogging and deterioration of the nozzles 64 may be minimized, if not prevented. Additionally, particles dispensed onto the substrate 12 from the nozzles 64 are minimized, which may also reduce defects of imprints produced utilizing the fluid dispense system 32. Further, although the filter 66 is shown between the fluid supply 62 and the dispense head 60, the filter 66 may be located in other portions of the fluid dispense system 32. For example, the filter 66 may be a component of the fluid supply 62. In addition, filter 66 may represent multiple filters.

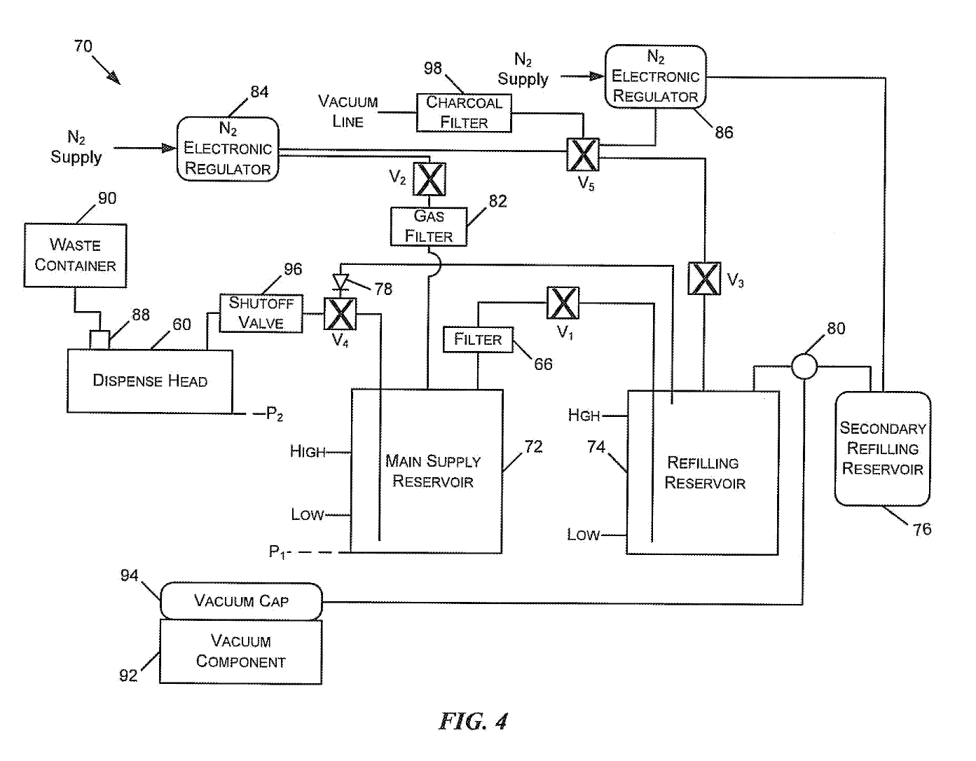

Fluid dispense system 32 may include a fluid transfer system 70, as illustrated in FIG. 4. The fluid transfer system 70 includes a main supply reservoir 72 and a refilling reservoir 74. Additionally, a secondary refilling reservoir 76 may be used. Secondary refilling reservoir 76 may be connected to refilling reservoir 74. In an implementation, reservoirs 72, 74, and/or 76 may be made of substantially ion-free and particle-free materials. For example, reservoirs 72, 74, and/or 76 may be made of Teflon or like material.

Tubing may connect main supply reservoir 72, refilling reservoir 74, and dispense head 76. In an implementation, tubing may be made of substantially ion-free and particle-free materials. For example, tubing may be made of Teflon, FEP and/or the like. The fluid transport system 70 also includes valves V₁-V₅ for controlling the flow of fluids and gases through the fluid transport system 70.

A filter 66 may be located between supply reservoir 72 and refilling reservoir 74. For example, a 50 nm filter made of polyethylene may be used to filter out particles generated in the refilling reservoir 74.

Fluid, such as the polymerizable material 34, may be circulated from supply reservoir 72 back to refilling reservoir 74. For example, as illustrated in FIG. 4, valve V₄ and a check valve 78 may provide fluid to be circulated from supply reservoir 72 to refilling reservoir 74. As such, fluid may be further filtered by filter 66. In some embodiments, an additional filter (not shown) may be placed between refilling reservoir 74 and secondary refilling reservoir 76 for further cleaning of the fluid. The fluid transfer system 70 also includes a refilling port 80 between the refilling reservoir 74 and the secondary refilling reservoir 76.

Generally, supply reservoir 72 and refilling reservoir 74 may be open to the atmosphere. Pressure may be adjusted by moving the supply reservoir plane P₁ either above or below the dispense head plane P₂. For example, supply reservoir may be moved either above or below the dispense head plane P₂ to provide a supply pressure, such as −500+/−133 Pa.

Nitrogen may be used to pressurize the supply reservoir 72 and/or the refilling reservoir 74. Additionally, nitrogen gas may be used to provide force to move fluid between the supply reservoir 72, the refilling reservoir 74, and/or dispense head 60. One or more gas filters 82 may be coupled to an N₂ electronic regulator 84. The N₂ electronic regulator 84 provides nitrogen gas from the N₂ supply to the supply reservoir 72 and the refilling reservoir 74. The gas filters 82 may be made of materials such as polytetrafluoroethylene and the gas filters 82 may filter out particles greater than 50 nm. An additional N₂ electronic regulator 86 provides nitrogen gas from the N₂ supply to the secondary refilling reservoir 76.

Electronic grade isopropyl alcohol (IPA) may be used to clean supply reservoir 72 and/or refilling reservoir 74. Additionally, a vigorous agitation of supply reservoir 72 and/or refilling reservoir 74 may be performed during cleaning to shed particles into the IPA. The IPA may then be recirculated through the fluid transfer system 70 to filter out particles. For example, particles may be purged out of nozzles of the dispense head 60, such as the nozzles 64 of FIG. 3.

The fluid transfer system 70 may be dried out prior to introduction of fluid into supply reservoir 72 and/or refilling reservoir 74. Drying may prevent intermixing between materials and IPA that may affect behavior of fluid leading to defective imprints. Additionally, dispense head 60 may be flushed with a cleaning solvent to prime fluid dispense system 32 and/or nozzles 64 (shown in FIG. 3).

Fluid may be introduced in the refilling reservoir 74 and transferred to the supply reservoir 72. Level sensors may be present on one or both reservoirs 72 and 74 to monitor the level of fluid in each reservoir 72 or 74 during transfer of fluid. Level sensors may include, but are not limited to, capacitive sensors, laser sensors, and/or the like.

Nozzles of the dispense head 60 may be primed using nitrogen. For example, nozzles may be primed using nitrogen at a specified pressure, such as 0.2 bars, to pressurize the supply reservoir 72 and force fluid through dispense head 60 (e.g., for 60 seconds). Additionally, air bubbles may be forced out of dispense head 60 by opening an outlet port 88 of the dispense head to allow air to push through tubing to a waste container 90.

A vacuum component 92, such as a pump, may be used to produce a partial vacuum to prime dispense head 60. For example, a vacuum component 92 may be connected to a vacuum cap 94 on dispense head 60. With the shutoff valve 96 closed, vacuum component 92 may be powered and the vacuum level may be allowed to build up in the refilling reservoir 74 via a vacuum line connected to a charcoal filter 98. For example, the vacuum level may be allowed to build up to a particular pressure, such as approximately −970 mBar. Subsequently, the shutoff valve 96 may be opened and fluid may be allowed to flow through nozzles of the dispense head 60. Fluid may then be allowed to flow into the refilling reservoir 74. Once fluid fills the refilling reservoir 74, the vacuum component 92 may be de-powered. Nitrogen may be provided to refilling reservoir 74 at a specified pressure, such as 1 bar, and fluid may be filtered through the supply reservoir 72. As fluid fills the supply reservoir 72, the vacuum component 90 may be powered and fluid may be circulated through dispense head 60 to refilling reservoir 74. In this manner, the volume in the supply reservoir 72 may be reused in a closed loop system.

Dispense head 60 may also be purged for the purpose of filling nozzles of the dispense head 60, removing particles at the surface of nozzles of the dispense head 60, or for general dispense head 60 maintenance. For example, dispense head 60 may be purged at a specified pressure, such as 0.1-0.2 bar, for a particular amount of time to dislodge particles that may be present at nozzles of the dispense head 60. Additionally, nozzles may be blotted to remove excess liquid deposited from the purge. For example, the nozzles of the dispense head 60 may be blotted with a polyknit wipe.

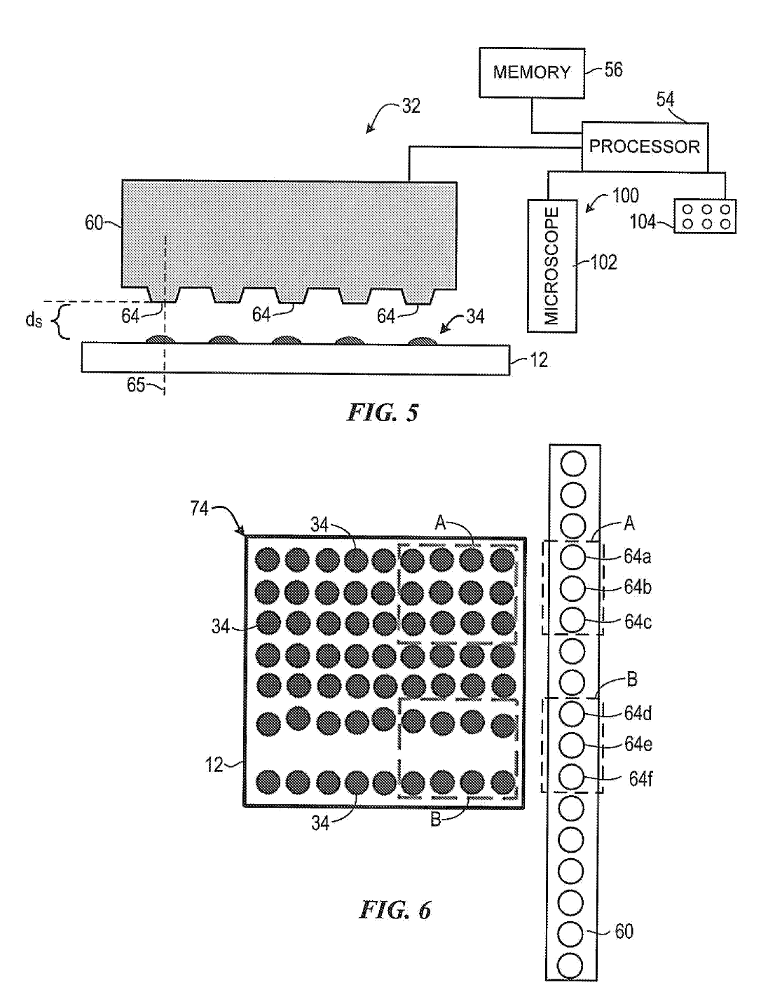

As described above, fluid dispense system 32 may be used to deposit polymerizable material 34 on substrate 12. FIG. 5 illustrates a fluid dispense system 32 comprising a dispense head 60 for depositing polymerizable material 34 on substrate 12. Dispense head 60 may comprise micro-solenoid valves or piezo-actuated dispensers.

Generally, polymerizable material 34 propagating through dispense head 60 egresses from at least one nozzle 64. In particular, drops of polymerizable material 34 may be ejected from at least one nozzle 64 toward substrate 12. It should be noted that a single nozzle 64 or multiple nozzles 64 may be used depending on design considerations. To that end, each nozzle 64 of dispense head 60 defines a dispensing axis 65 along which polymerizable material 34 may be deposited on substrate 12.

As illustrated in FIG. 5, fluid dispense system 32 may optionally be connected to a vision system 100. Vision system 100 may comprise a microscope 102 (e.g. optical microscope) to provide images 104 of polymerizable material 34 placement on substrate 12. Microscope 102 may be regulated by processor 54 and further may operate on a computer readable program stored on memory 56. Images 104 may be provided at periodic intervals during the imprinting process. Alternatively, images 104 may be provided during a periodic dispense performed to prevent evaporation.

Nozzle 64 of dispense head 60 may become clogged or deviated due to evaporation at nozzle 64, particles in the polymerizable material 34, inadvertent contact with other components of the fluid dispensing system 32, physical and/or electrical failure of fluid dispensing system 32 and/or the like. Thus, dispense head 60 may need to be replaced periodically. For example, dispense head 60 may need to be replaced as nozzles 64 deviate from dispensing fluid in specified locations or if nozzles 64 fail to dispense due to an electrical or mechanical failure within dispense head 60. Images 104 may be used to identify poor drop placement and may provide information as to whether dispense head 60 needs to be replaced, whether maintenance of the dispense head 60 needs to be performed, and/or whether other measures should be taken to compensate for any non-functional nozzles.

Image 104 may provide a visual of a portion of polymerizable material 34 dispensed from nozzles 64 for identifying polymerizable material 34 placement and determining nozzle 64 functionality. FIG. 6 illustrates an exemplary image 104 and associated nozzles 64 of dispense head 60. Nozzles 64 deposit polymerizable material 34 in a prescribed pattern on substrate 12. For example, the prescribed pattern may be a series of columns and rows.

Based on the image 104 of deposited polymerizable material 34 on substrate 12, nozzle 64 functionality may be determined. For example, image 104 shows that nozzles 64a-c within section A of dispense system 62 deposit droplets of polymerizable material 34 on substrate 12 in the prescribed pattern of columns and rows. As the droplets of polymerizable material 34 visually appear and do not deviate from the prescribed pattern, nozzles 64a-c may be determined to be functional. Image 104 also shows droplets of polymerizable material 34 within section B deposited by nozzles 64d-f of dispense head 60. In particular, droplets of polymerizable material 34 associated with nozzle 64e are not visually apparent. Additionally, droplets of polymerizable material 34 associated with nozzle 64d deviate from the prescribed pattern. As such, nozzles 64d and 64e may be determined to be non-functioning. Further, a particular nozzle may deposit droplets of the polymerizable material 34 according to the prescribed pattern, but the droplets may have a volume smaller than a threshold volume of droplets that is needed during the imprint lithography process. Thus, when a nozzle dispenses droplets that include an amount of polymerizable material 34 that is less than the threshold amount, the nozzle may be considered non-functional. One or more of the nozzles 64 may also be considered non-functioning when too much fluid is dispensed at a particular location of the prescribed pattern.

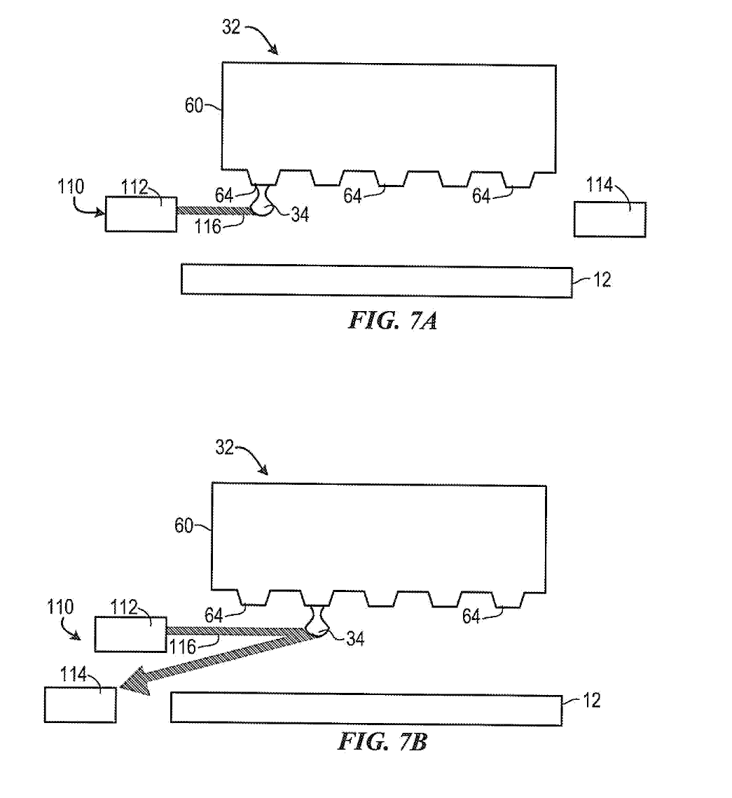

As illustrated in FIGS. 7A and 7B, fluid dispense system 32 may optionally comprise a detection system having at least one sensor 110 for detecting polymerizable material 34 as polymerizable material 34 egresses from nozzles 64 toward substrate 12. Sensor 110 may include, but is not limited to electromagnetic, mechanical, chemical, optical radiation, ionizing radiation, acoustic, and/or the like. For example, sensor 110 may be an optical radiation sensor comprising a scanning laser 112 and a detector 114 as illustrated in FIG. 7A. Laser 112 may provide a beam of laser light, multiple beams of laser light, or a sheet of laser light positioned between nozzles 64 and substrate 12. FIG. 7A illustrates a beam 116 of laser light. Detector 114 may detect the presence of polymerizable material 34 egressing from nozzle 64 toward substrate 12 when polymerizable material 34 blocks the beam 116 of laser light. Alternatively, detector 114 may detect the presence of polymerizable material 34 egressing from nozzle 64 toward substrate 12 by measuring reflection and/or defraction of beam 116 as illustrated in FIG. 7B.

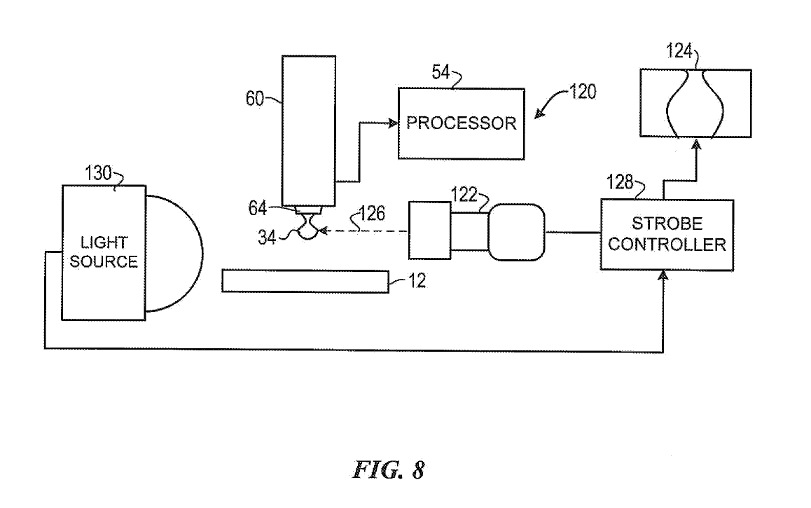

As illustrated in FIG. 8, fluid dispense system 32 may optionally comprise a monitoring system 120 having a camera 122 (e.g., high speed camera) for capturing one or more images 124 of polymerizable material 34 egressing from nozzle 64 toward substrate 12. Image 124 may be captured for an individual nozzle or multiple nozzles. Camera 122 line of sight 126 may be between nozzle 64 and substrate 12. In one example, monitoring system 120 further comprises a strobe controller 128 regulating a light source 130 to provide a strobing technique. Camera 122 and strobe controller 128 may be designed to provide multiple sequential images 124 of polymerizable material 34 as polymerizable material 34 egresses from nozzle 64 toward substrate 12. For example, if polymerizable material 34 is present in one image 124 and not in subsequent images 124, then nozzle 64 may be determined to be non-functional.

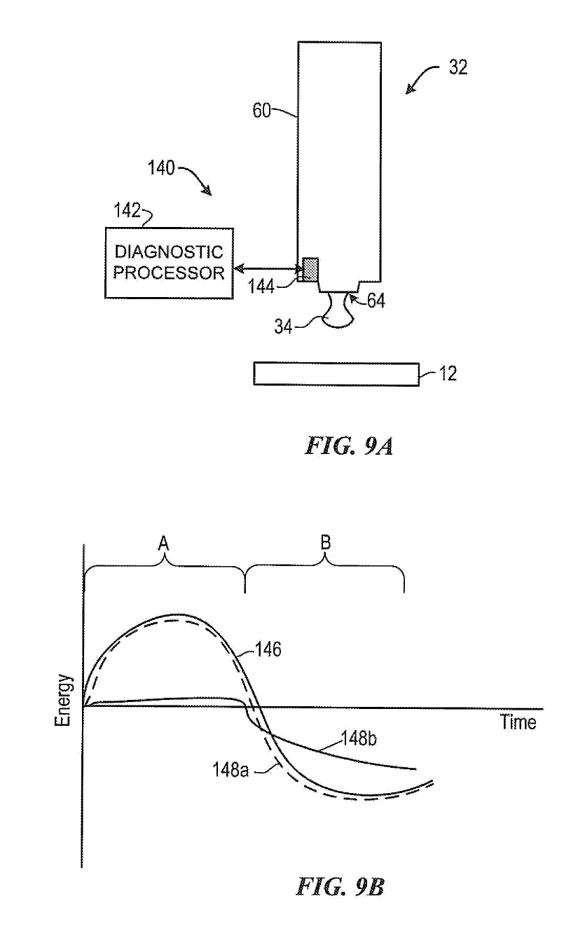

As illustrated in FIGS. 9A and 9B, fluid dispense system 32 may optionally comprise a diagnostic system 140 having a diagnostic processor 142 and a diagnostic sensor 144 positioned within dispense head 60. For example, diagnostic sensor 144 may be attached to the piezo crystal in a piezo-actuated dispenser. In a further implementation, diagnostic sensor 144 may be positioned within any part of fluid dispense system 32. Diagnostic sensor 144 may provide information regarding which nozzles 64 are functional and non-functional. For example, diagnostic sensor 144 may provide data, such as a resonance wave (e.g., acoustic pressure), that is generated when each nozzle 64 of dispense head 60 is activated. In a particular illustrative embodiment, diagnostic processor 142 may compare the resonance wave generated by each nozzle 64 to a baseline wave 146 to determine whether a nozzle 64 may be functional or non-functional. The baseline wave 146 may be produced on a known functional nozzle 64 as polymerizable material 34 egresses from nozzle 64 (Section A) and separates from nozzle 64 (Section B). A resonance wave from a functional nozzle 64 is illustrated by numeral 148a. A resonance wave from a non-functional nozzle 64 is illustrated by numeral 148b. It should be noted that processor 54 (shown in FIG. 1) may be used in addition to or in lieu of diagnostic processor 142.

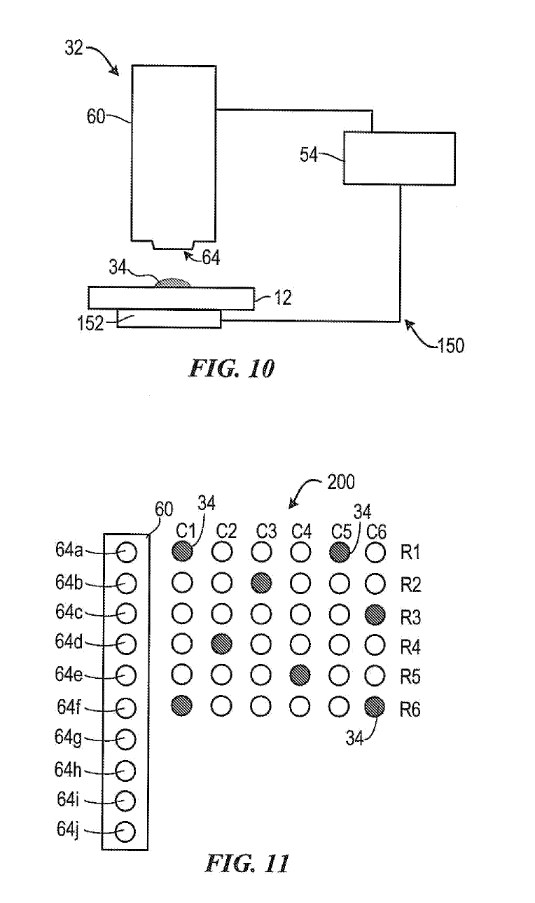

As illustrated in FIG. 10, fluid dispense system 32 may optionally comprise a gravimetric system 150 to monitor changes in a mass of polymerizable material 34 to provide information regarding a functionality of nozzles 64. For example, gravimetric system 150 may comprise a sensor scale 152 positioned to capture polymerizable material 34 egressing from nozzle 64. In an illustrative embodiment, the processor 54 may be utilized to determine whether a particular nozzle 64 is functional or non-functional based on changes in the mass of polymerizable material 34 dispensed from the particular nozzle 64 as measured by the sensor scale 152. Sensor scale 152 may be separate from, or integral to, substrate 12. FIG. 10 illustrates a gravimetric system 150 comprising sensor scale 152 separate from substrate 12. Gravimetric system 150 monitors increases and/or decreases in mass of polymerizable material 34 at a pre-determined frequency. For example, gravimetric system 150 may sample increases in mass of polymerizable material 34 at a frequency of no less than 2 kHz. Sampling by sensor system 152 may be provided in an air flow-free environment to eliminate evaporation and/or bias.

There are several techniques that may be applied to minimize the effect of nozzles 64 that may be determined to be non-functional. Generally, techniques fall into two categories: lossless techniques that provide the exact drop pattern initially intended, and lossy techniques that provide an altered drop pattern but minimize the effect on the final imprint. Both the lossless techniques and the lossy techniques may be implemented by a computer, processor, such as the processor 54, or other computing device based on computer-readable instructions stored on one or more computer-readable storage media, such as computer-readable instructions stored on computer-readable storage media of memory 56. The computer-readable storage media can be any available media that can be accessed by a computing, device to implement the instructions stored thereon.

FIG. 11 illustrates an exemplary drop pattern 200. Nozzles 64a-j of dispense head 60 may selectively provide droplets within rows R1-R6 and columns C1-C6. Droplets of polymerizable material 34 are illustrated as solid marks, and unfilled marks represent unused but available locations (also referred to herein as “empty locations”) for droplets. For example, in FIG. 11 nozzle 64a may provide one droplet of polymerizable material 34 at (R1, C1) and one droplet of polymerizable material 34 at (R1, C5), of the 6 potential locations (R1, C1-C6).

### Lossless Techniques

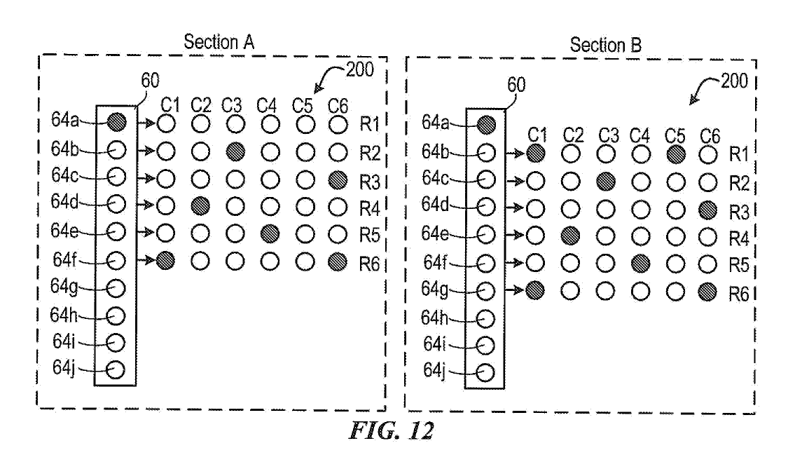

FIG. 12 illustrates an exemplary lossless technique to provide drop pattern 200 using nozzle shifting. For example, in FIG. 12, dispense head 60 may be designed to use six nozzles 64a-f to provide drop pattern 200 as represented by Section A. As illustrated, nozzle 64a may be substantially non-functional, and thus not provide sufficient droplets of polymerizable material 34 at (R1, C1) and (R1, C5). By shifting dispense head 60, a different nozzle other than 64a on dispense head 60 may be used to provide drop pattern 200. For example, in FIG. 12, dispense head 60 may be redesigned to use nozzles 64b-g to provide drop pattern 200 as represented by Section B. As nozzle shifting provides for the use of different nozzles of dispense head 60 than what may have been previously intended, substrate 12 may be moved to compensate accordingly. For example, substrate 12 may be moved such that nozzle 64a is not in use as illustrated by FIG. 12.

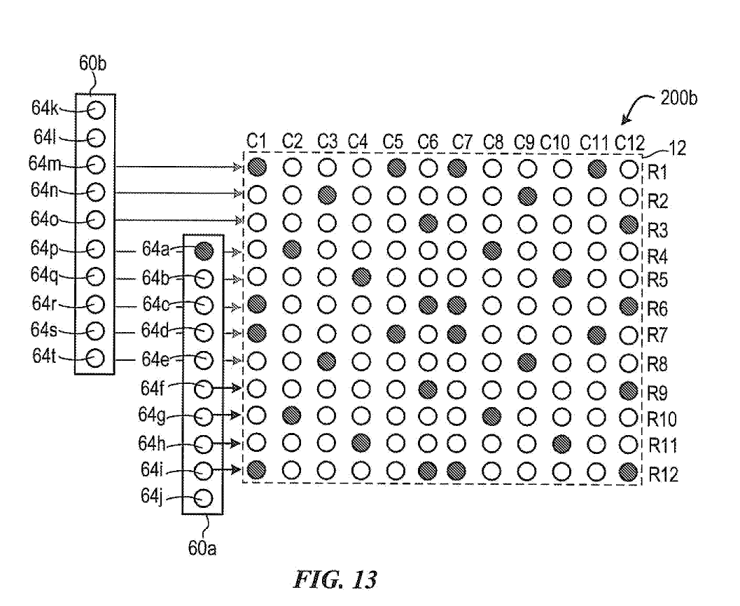

FIG. 13 illustrates an exemplary lossless technique to provide drop pattern 200b using dispense head stitching. Dispense head stitching generally involves using multiple dispense heads 60 in concert to provide drop pattern 200b without typically having to move substrate 12. By using stitching adjustment, non-functional nozzles 64 of one dispense head 60 may be compensated for by using functional nozzles 64 of another dispense head 60. For example, as illustrated in FIG. 13, dispense heads 60a and 60b may provide drop pattern 200b. Nozzle 64a may be substantially non-functional, and thus not provide sufficient droplets of polymerizable material 34 at (R4, C2) and (R4, C8) of drop pattern 200b. Using stitching adjustment, functional nozzle 64p of dispense head 60b may be used to dispense droplets of polymerizable material 34 at (R4, C2) and (R4, C8) of drop pattern 200b to compensate for non-functional nozzle 64a of dispense head 60a.

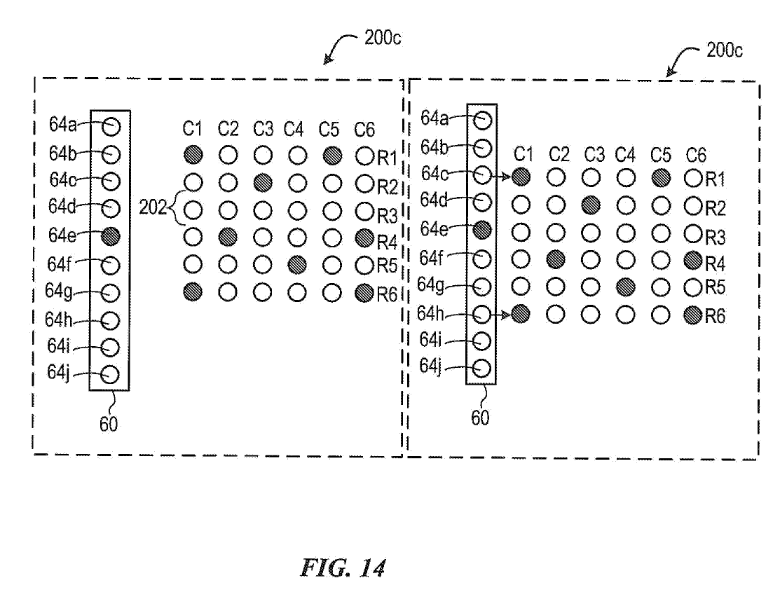

FIG. 14 illustrates an exemplary lossless technique to provide drop pattern 200c using gap-straddling. In some situations, drop pattern 200c may have one or more gaps 202 at least as large as a nozzle 64 of dispense head 60. That is, the drop pattern 200c may include one or more rows of empty locations. Thus, it may be possible to align a non-functional nozzle 64 with the gap 202. For example, FIG. 14 illustrates drop pattern 200c wherein gap 202 is between R2 and R4. If nozzle 64e is considered non-functional, substrate 12 may be moved such that nozzle 64e aligns with gap 202.

### Lossy Techniques

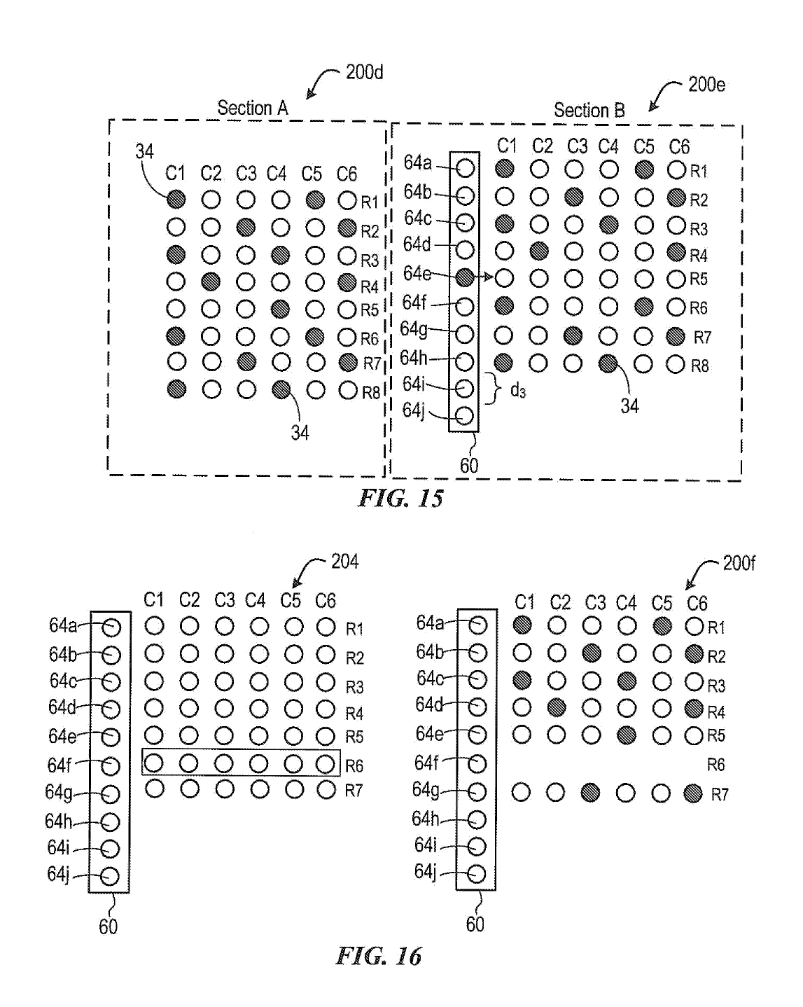

FIG. 15 illustrates an exemplary lossy technique to alter drop pattern 200d using minimized-straddling to provide drop pattern 200e that minimizes the effect of one or more non-functional nozzles 64 of dispense head 60. Generally, minimized-straddling includes analyzing all rows of drop pattern 200d to determine a suitable row that includes a minimal number of drop locations of polymerizable material 34 as prescribed by drop pattern 200d. For example, FIG. 15 illustrates drop pattern 200d in section A. Nozzle 64e may be considered non-functional and as such droplets of polymerizable material 34 may not be provided according to the prescribed drop pattern 200d. For example, nozzle 64e in section A does not provide for droplets of polymerizable material 34 at (R4, C2) and (R4, C6). Using minimized-straddling, drop pattern 200d may be analyzed to determine a suitable row that includes a small amount of droplets, such as Row 5. Substrate 12 may be moved such that nozzle 64e may be aligned with Row 5 providing adjusted drop pattern 200e. Adjusted drop pattern 200e may minimize the effect of non-functional nozzle 64e on residual layer thickness t₂, residual layer uniformity, and/or the like as compared to using drop pattern 200d and non-functional nozzle 64e.

FIG. 16 illustrates an exemplary lossy technique to alter drop pattern 200e using basegrid adjustment to provide drop pattern 200f that minimizes the effect of one or more non-functional nozzles 64 of dispense head 60. In using centroidal Voronoi tessellation (CVT), power centroidal Voronoi tessellation (PCVT), and other drop pattern generation methods, a basegrid 204 may be used. The basegrid 204 is generally a set of all possible drop locations that fall within the patterned area of substrate 12. Generally, a subset of these drop locations may be selected for placement of polymerizable material 34 to fill the volume between patterned substrate layer 46 and template 18. If one or more nozzles 64 are determined to be non-functional, the non-functional nozzles 64 may be removed from the basegrid 204. For example, as illustrated in Section A, nozzle 64f may be considered non-functional. As such, nozzle 64f may be removed from consideration within basegrid 204 as illustrated in Section B. Removing nozzle 64f from basegrid 204 may provide for drop pattern 200f.

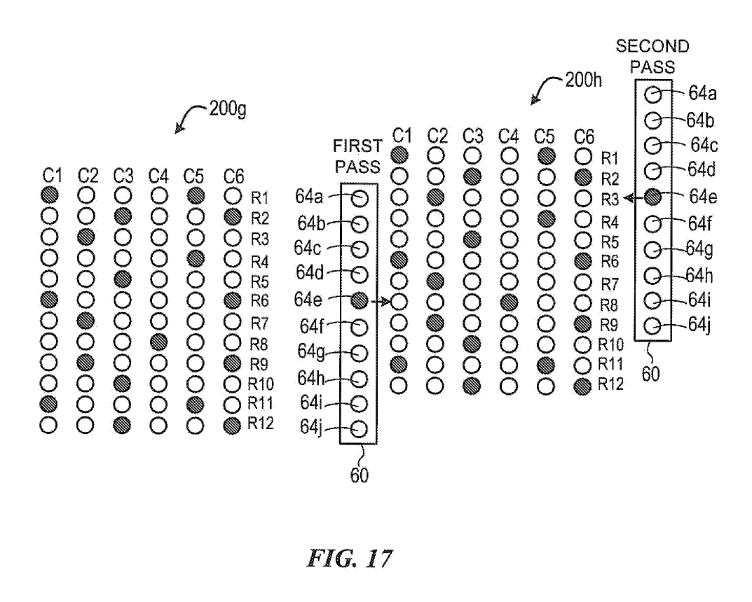

FIG. 17 illustrates an exemplary lossy technique to alter drop pattern 200g using enhanced-multipass-shifting to provide drop pattern 200h that minimizes the effect of one or more non-functional nozzles 64 of dispense head 60. Multiple passes of dispense head 60 may be performed over substrate 12. Such passes may generally be shifted to provide droplets of polymerizable material 34 at an increased spatial frequency. For example, as illustrated in FIG. 17, dispense head 60 may be set up to provide drop pattern 200g; however, nozzle 64e of dispense head 60 may be non-functional. During a first pass, nozzle 64e may not provide droplets of polymerizable material 34 in Row 8. By shifting dispense head 60 and providing a second pass, nozzle 64e may be placed at a distance from Row 8. This may ensure that non-dispensed rows are not adjacent and the effect on residual layer thickness may be reduced. In addition, droplets of polymerizable material 34 may be dispensed in Row 8 by other nozzles of the dispense head 60, such as the functional nozzle 64i, during the second pass.

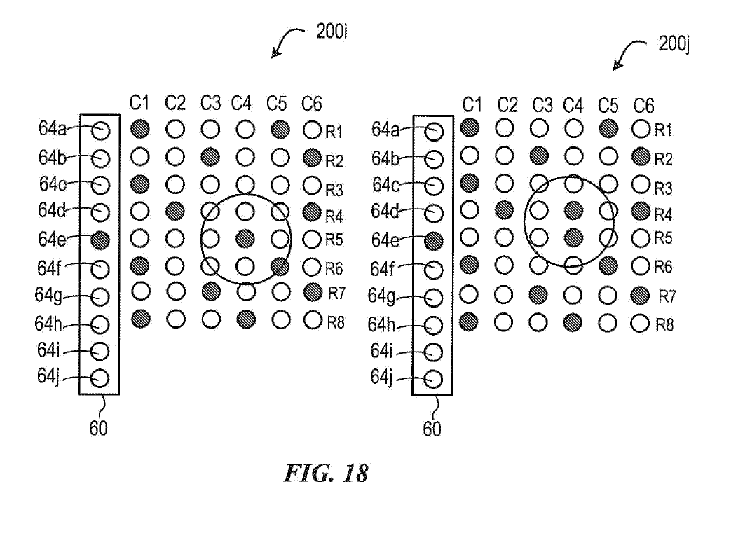

FIG. 18 illustrates an exemplary lossy technique to alter drop pattern 200i using neighbor mapping to provide drop pattern 200j that minimizes the effect of one or more non-functional nozzles 64 of dispense head 60. Generally, in neighbor mapping, non-functional nozzles 64 may be compensated for by an adjacent functional nozzle. For example, dispense head 60 may include non-functional nozzle 64e. Drop pattern 200i may be analyzed to determine locations affected by non-functional nozzle 64e (e.g., (R5, C4)). Potential neighbor locations may be determined for compensation of non-functional nozzle 64e. The potential neighbor locations may comprise empty locations that are adjacent to the locations affected by the non-functional nozzle 64e. As such, drop pattern 200i may be altered to provide for drop pattern 200j wherein nozzle 64d or nozzle 64f dispenses polymerizable material 34 in one of the neighbor locations (R4, C4) or (R6, C4), respectively. Neighbor locations may be further analyzed to determine which neighbor location may be best suited for compensating non-functional nozzle 64e. For example, neighbor location (R6, C4) is in close proximity to a location at which other polymerizable material 34 may be dispensed (i.e., (R6, C5). As such, dispensing of polymerizable material 34 by nozzle 64d at (R4, C4) may be a more suitable location for compensation than dispensing of polymerizable material 34 by nozzle 64f at (R6, C4).

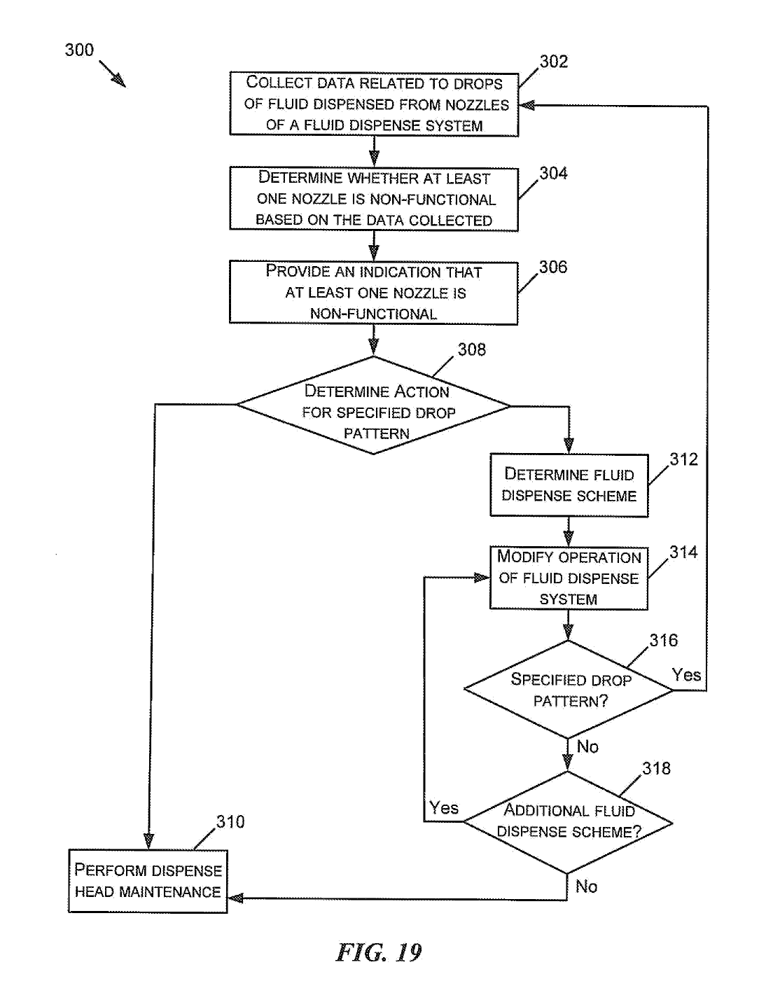

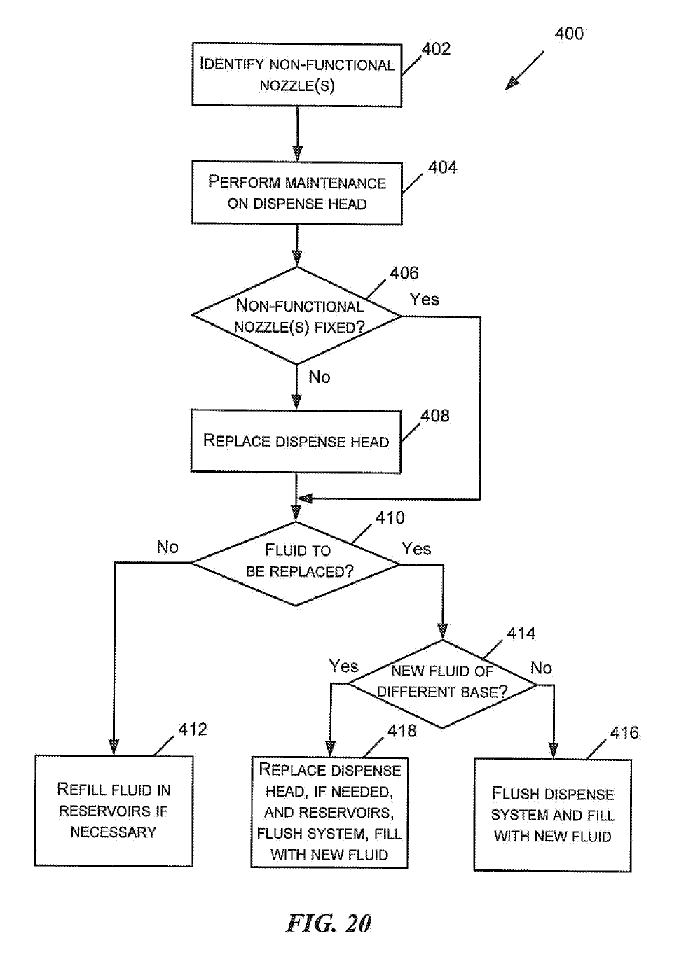

Specifics of exemplary methods are described below with respect to FIG. 19 and FIG. 20. However, it should be understood that certain acts need not be performed in the order described, and may be modified, and/or may be omitted entirely, depending on the circumstances. Moreover, the acts described may be implemented by a computer, processor or other computing device based on computer-readable instructions stored on one or more computer-readable storage media. The computer-readable storage media can be any available media that can be accessed by a computing device to implement the instructions stored thereon.

FIG. 19 illustrates a flow chart of an exemplary method 300 to identify non-functional nozzles and obtain a specified drop pattern. The method 300 may be implemented via the systems and techniques described with respect to FIGS. 1-18. At 302, data is collected related to droplets of fluid dispensed from nozzles 64 of dispense head 60 of fluid dispense system 32. One or more techniques may be utilized to collect the data. For example, images of droplets dispensed onto substrate 12 may be captured. Further, changes in the mass of droplets dispensed from nozzles 64 may also be measured. Additionally, and/or alternatively, data may be collected by sensors associated with each of the nozzles 64 when the nozzles 64 are activated by measuring pressure that is built up and dissipated as a droplet forms and is subsequently dispensed within each particular nozzle 64. Data related to the functionality of the nozzles 64 may be collected individually for each particular nozzle at any given time, collected for a particular group of nozzles 64 at any given time, for all nozzles 64 at any given time, or a combination thereof, depending on the technique or techniques utilized to collect the data.

At 304, the method 300 includes determining whether at least one nozzle of the nozzles 64 is non-functional based on the data collected. For example, the data collected may indicate that little or no fluid is dispensed from a particular nozzle. In another example, the data collected may indicate that too much fluid is dispensed by a particular nozzle. Further, the data collected may indicate that a nozzle is non-functional because fluid is dispensed from the nozzle at an angle that deviates from the desired angle.

In some embodiments, images of a pattern of droplets dispensed onto substrate 12 may be compared to a prescribed drop pattern. The comparison between the pattern of drops dispensed onto the substrate 12 and the prescribed drop pattern may be performed via visual inspection by an operator of lithographic system 10 and/or the comparison may be performed automatically utilizing software stored in memory 56. When an error is identified during the comparison between the prescribed drop pattern and the actual pattern of drops, one or more nozzles 64 of dispense head 60 may be considered non-functional. In some instances, the error in the actual pattern of drops may be indicated by an empty location of the substrate that is filled in the prescribed drop pattern. In other instances, the error in the actual pattern of drops may be indicated by an amount of fluid, such as the volume of fluid, in a particular location of the substrate 12 that is above or below a threshold amount. For example, some nozzles 64 may dispense some fluid, but not enough to provide adequate coverage of the substrate 12 during an imprint lithography process. In another example, one or more nozzles 64 may dispense too much fluid onto the substrate 12. An error in the actual pattern of drops may also be indicated by droplets from a particular nozzle being dispensed in a location of the substrate 12 that corresponds to a location associated with a different nozzle.

After identifying any non-functional nozzles 64, an indication is provided at 306 that at least one nozzle of dispense head 60 is non-functional. The indication may specify the particular non-functional nozzles. The indication may be provided in the form of a warning light, an audio sound, a message, such as an email message, a pop-up window or other indicator of a graphical user interface, or any combination thereof.

At decision 308, one or more actions are determined to address the non-functional nozzles 64 and achieve a proper drop pattern. In some instances, the method 300 proceeds to 310 where maintenance is performed on the dispense head 60. Maintenance of the dispense head may include replacement of the dispense head 60, if necessary. Further details regarding maintenance of the dispense head 60 are explained with respect to FIG. 20. In other instances, the method 300 moves to 312 where one or more fluid dispense schemes are determined in order to compensate for the non-functional nozzle(s) 64. Examples of fluid dispense schemes include the lossless and lossy techniques discussed with respect to FIGS. 12-18.

At 314, operation of the fluid dispense system 32 is modified in accordance with the fluid dispense: scheme. For example, nozzles 64 of dispense head 60 may be shifted in order to remove the non-functional nozzle(s) 64 from use or to associate the non-functional nozzle(s) 64 with rows of a prescribed drop pattern that include a minimal number of drop locations or do not include any drop locations. In another example, multiple dispense heads 60 may be utilized or multiple passes of a single dispense head 60 may be utilized to compensate for the non-functional nozzles 64. In still other examples, the prescribed drop pattern may be altered to remove any rows including drop locations associated with the non-functional nozzle(s) 64 or to dispense fluid to locations of a substrate adjacent to the locations affected by the non-functional nozzle(s) 64.

At 316, the method 300 includes determining whether a specified drop pattern has been achieved in accordance with the fluid dispense scheme(s) utilized. That is, the lithographic system 10 determines whether implementation of the fluid dispense scheme(s) achieved a desired result and produced a pattern of droplets that compensates for the non-functional nozzles 64. To illustrate, with respect to lossless techniques, software stored on the memory 54 may be executed to determine whether the prescribed drop pattern was achieved after implementing the fluid dispense scheme(s). With respect to lossy techniques, software stored on the memory 54 may be executed to determine whether a pattern of drops was dispensed that will achieve coverage of the fluid on the substrate 12 that is adequate for a particular imprint lithography process.

When the specified drop pattern is achieved, the method 300 returns to 300 to continue collecting data to identify non-functional nozzles 64. When the specified drop pattern is not achieved, the method advances to 318. At 318, one or more additional fluid dispense schemes are determined. For example, when one particular lossless or lossy technique was unsuccessfully utilized in an attempt to compensate for the non-functional nozzles 64, software stored on the memory 54 may be executed to implement another lossless or lossy technique. In another example, if lossless techniques were not successful in achieving a prescribed pattern of drops, then software stored on the memory 54 may be executed to implement one or more lossy techniques. If further fluid dispense schemes are not available or applicable, the method 300 proceeds to 310 where dispense head maintenance is performed.

FIG. 20 illustrates a flow chart of an exemplary method 400 to maintain a dispense head 60. The method 400 may be implemented by the systems shown in FIGS. 1-4. At 402, non-functional nozzles 64 of dispense head 60 are identified. For example, non-functional nozzles 64 may be identified utilizing the techniques discussed with respect to FIGS. 5-10. To illustrate, non-functional nozzles 64 may be identified by images of droplets dispensed onto a substrate 12, by images of droplets egressing from nozzles 64, by diagnostic sensors associated with one or more of the nozzles 64, and/or by measuring changes in mass of droplets dispensed from the nozzles 64.

At 404, maintenance is performed on dispense head 60 in an attempt to fix the non-functional nozzles. For example, the dispense head 60 may be purged by pressurizing the main supply reservoir 72 using nitrogen gas at a specified pressure, such as 0.2 bar. Purging the dispense head 60 may purge air bubbles and/or dislodge material around nozzles 64, such that fluid can flow through the nozzles 64 more freely. Dispense head 60 may also be purged while dispensing fluid to produce a sonication effect on dispense head 60 that may dislodge material blocking nozzles 64. Additionally, dispense head 60 may be wiped with an IPA-soaked clean wipe horizontally across nozzles 64 to remove material blocking nozzles 64. Vacuum wiping may also be utilized to remove material blocking nozzles 64. Further, dispense head 60 may be disconnected from fluid transfer system 70 to allow fluid to drain out of dispense head 60 and air trapped inside nozzles 64 may also be released. After a pre-determined time (e.g., 3 minutes), fluid transport system 70 may be reconnected to fill the nozzles 64 of dispense head 60.

At decision 406, the method 400 determines whether a threshold number of non-functional nozzles 60 have been fixed. For example, the dispense head 60 may be operable to dispense fluid in a pattern that covers the substrate 12 in an adequate manner for a particular imprint lithography process with a specified threshold number of non-functional nozzles 64. Thus, when the dispense head 60 includes a number of non-functional nozzles 64 less than the threshold number, the method 400 advances to 410. In some instances, the techniques utilized to identify the non-functional nozzles 64 described with respect to 402 may again be implemented to determine whether or not the non-functional nozzles 64 are functioning properly after maintenance of dispense head 60.

When the threshold number of non-functional nozzles 64 has not been fixed, the method 400 moves to 408. At 408, the dispense head 60 is replaced. After the dispense head 60 is replaced, the dispense head 60 may be flushed with a cleaning solvent to prime the fluid lines of the fluid transport system 70 and the nozzles 64 of the dispense head 60. In addition, after flushing the fluid transport system 70 with cleaning solvent, the refilling reservoir 74 may be filled with fluid, the fluid may then be: transferred to the main supply reservoir 72 and the dispense head 60 is primed. A particular process for filling the reservoirs 72 and 74 with fluid and priming dispense head 60 is described with respect to FIG. 4.

At 410, the method 400 determines whether the fluid dispensed by the dispense head 60 is to be changed to a new fluid. When the fluid does not need to be changed, the method proceeds to 412 where the fluid in the reservoirs 72 and 74 is refilled, if necessary. When the fluid is to be changed to a new fluid, the method 400 moves to 414. At decision 414, the method 400 determines whether the new fluid is comprised of a different base formulation than the current fluid. For example, the current fluid may be comprised of an organic monomer base formulation. Thus, at 414, the method 400 determines whether the new fluid is also comprised of an organic monomer base formulation. When the new fluid is comprised of a base formulation that is similar to the base formulation of the current material, then the method 400 advances to 416, where the fluid transport system 70 is flushed, the dispense head 60 is primed, and the reservoirs 72 and 74 are filled with the new fluid. Otherwise, the method 400 moves to 418.

At 418, the dispense head 60 is replaced if needed. That is, if the dispense head 60 was already replaced, such as in 408 of the method 400, and the current fluid has not been dispensed through the new dispense head, then the dispense head 60 does not need to be replaced at 418. However, if the dispense head 60 has not already been replaced and/or has been used with the current fluid, then the dispense head 60 is replaced. After the dispense head 60 is replaced, the reservoirs 72, 74, and 76 are also replaced. The fluid transport system 70 is then flushed with cleaning solvent, the reservoirs 72 and 74 are filled with the new fluid, and the dispense head 60 is primed with the new fluid. A particular process for filling the reservoirs 72 and 74 with fluid and priming dispense head 60 is described with respect to FIG. 4.

What is claimed is:

1. An apparatus comprising:
a dispense head including a plurality of nozzles;
a fluid supply connected to the dispense head;
a processor; and
memory coupled to the processor, the memory including computer-readable instructions executable by the processor to identify a non-functional nozzle of the plurality of nozzles.

2. The apparatus of claim 1, wherein the memory includes additional computer-readable instructions executable by the processor to:
collect data related to droplets of fluid dispensed from one or more of the plurality of nozzles; and
determine whether at least one nozzle of the plurality of nozzles is non-functional based on the data collected.

3. The apparatus of claim 1, further comprising a vision system to provide one or more images of a pattern of droplets of fluid dispensed onto a substrate via one or more of the plurality of nozzles, and wherein the memory includes additional computer-readable instructions executable by the processor to identify the non-functional nozzle by comparing the one or more images of the pattern of droplets of the fluid dispensed onto the substrate with a prescribed drop pattern.

4. The apparatus of claim 1, further comprising a sensor that detects fluid egressing from one or more of the plurality of nozzles.

5. The apparatus of claim 1, further comprising one or more diagnostic sensors to provide data related to activation of one or more of the plurality of nozzles, wherein each of the one or more diagnostic sensors is associated with a respective nozzle.

6. The apparatus of claim 1, further comprising a gravimetric system to monitor changes in mass of fluid dispensed from one or more of the plurality of nozzles.

7. The apparatus of claim 1, wherein the fluid supply comprises a main supply reservoir and a refilling reservoir, and wherein a filter is coupled between the main supply reservoir and the refilling reservoir.

8. The apparatus of claim 7, further comprising a nitrogen gas supply connected to the main supply reservoir and to the refilling reservoir, wherein the nitrogen gas provides force to move fluid between the main supply reservoir, the refilling reservoir, the dispense head, the filter, or a combination thereof.

9. One or more computer-readable media including computer-readable instructions that, when executed by a processor, perform acts comprising:
providing an indication that at least one nozzle of a plurality of nozzles of a fluid dispense system is non-functional;
determining a fluid dispense scheme to compensate for the at least one non-functional nozzle; and
modifying operation of the fluid dispense system according to the fluid dispense scheme.

10. The one or more computer-readable media of claim 9, wherein the acts further comprise identifying the at least one non-functional nozzle by identifying an error in a pattern of droplets dispensed by the plurality of nozzles when compared with a prescribed drop pattern, and wherein the prescribed drop pattern comprises a grid having rows including drop locations and empty locations.

11. The one or more computer-readable media of claim 10, wherein the acts further comprise activating a first set of the plurality of nozzles to dispense fluid according to the prescribed drop pattern, and wherein the first set of the plurality of nozzles includes the at least one non-functional nozzle, and wherein the fluid dispense scheme includes activating a second set of the plurality of nozzles to dispense the fluid to cover drop locations of the prescribed drop pattern that include an amount of the fluid that is less than a threshold amount.

12. The one or more computer-readable media of claim 10, wherein the acts further comprise activating a first plurality of nozzles of a first dispense head and a second plurality of nozzles of a second dispense head to dispense fluid according to the prescribed drop pattern, wherein the first plurality of nozzles includes the at least one non-functional nozzle, and wherein the fluid dispense scheme includes modifying operation of the second plurality of nozzles to dispense fluid in drop locations of the prescribed drop pattern that received an amount of the fluid that is less than a threshold amount.

13. The one or more computer-readable media of claim 10, wherein the acts further comprise identifying at least one row of the prescribed drop pattern comprised of empty locations, and, wherein the fluid dispense scheme includes modifying operation of the plurality of nozzles, such that the at least one non-functional nozzle is associated with a respective row of the prescribed drop pattern comprised of empty locations.

14. The one or more computer-readable media of claim 10, wherein the acts further comprise identifying at least one row of the prescribed drop pattern with a minimal number of drop locations, and wherein the fluid dispense scheme includes modifying operation of the plurality of nozzles such that the at least one non-functional nozzle is associated with a respective row of the prescribed drop pattern that includes the minimal number of drop locations.

15. The one or more computer-readable media of claim 10, wherein each row of the prescribed drop pattern is associated with a respective nozzle, and the fluid dispense scheme includes modifying the prescribed drop pattern by removing a respective row of the prescribed drop pattern associated with the at least one non-functional nozzle.

16. The one or more computer-readable media of claim 10, wherein the acts further comprise activating the plurality of nozzles during multiple passes of a substrate to dispense fluid to the substrate, and wherein the fluid dispense scheme includes modifying operation of the plurality of nozzles during at least one of the multiple passes in order to dispense the fluid to a row of the prescribed drop pattern associated with the at least one non-functional nozzle.

17. The one or more computer-readable media of claim 10, wherein the fluid dispense scheme includes identifying one or more empty locations of the prescribed drop pattern adjacent to a drop location of the prescribed drop pattern associated with the at least one non-functional nozzle and modifying operation of the plurality of nozzles by dispensing the fluid to at least one of the empty locations adjacent to the drop location of the prescribed drop pattern associated with the at least one non-functional nozzle.

18. A method comprising:
identifying, by a lithographic system, that at least one of a plurality of nozzles of a fluid dispense system of the lithographic system is non-functional;
performing maintenance on one or more nozzles of the fluid dispense system in response to identifying the at least one non-functional nozzle;
determining whether the maintenance fixed the at least one non-functional nozzle; and
replacing a dispense head of the fluid dispense system when the maintenance fails to fix a threshold number of non-functional nozzles.

19. The method of claim 18, further comprising:
determining whether a fluid dispensed by the fluid dispense system is to be changed; and
replacing one or more reservoirs of the fluid dispense system when the fluid is to be changed to another fluid with a different formulation.

20. The method of claim 18, wherein performing maintenance on the one or more nozzles of the fluid dispense system includes purging the dispense head with nitrogen gas, purging the dispense head by dispensing fluid through nozzles of the dispense head, wiping the dispense head with a wipe, vacuum wiping the dispense head, disconnecting the dispense head from the fluid dispense system, or a combination thereof.
